(19) United States
(12) Patent Application Publication
(10) Pub. No.: US 2018/0046345 A1
(43) Pub. Date: Feb. 15, 2018

(54) METHOD AND SYSTEM FOR ERASING AN ENCLOSED AREA ON AN INTERACTIVE DISPLAY

(71) Applicant: QuirkLogic, Inc., Calgary, CA (US)

(72) Inventors: Gorden Dean Elhard, Calgary (CA); Cheng Xu, Calgary (CA); Michael Howatt Mabey, Calgary (CA); Alfonso Fabian de la Fuente, Victoria (CA)

(21) Appl. No.: 15/347,481

(22) Filed: Nov. 9, 2016

Related U.S. Application Data
(63) Continuation-in-part of application No. 15/173,275, filed on Jun. 3, 2016.
(60) Provisional application No. 62/275,052, filed on Jan. 5, 2016.

(51) Int. Cl. G06F 3/0488

(52) U.S. Cl. CPC G06F 3/0488; G06F 3/0202

(57) ABSTRACT

A method and system for updating an interactive display on an interactive device. More specifically, the method is directed to the removal of identified stroke inputs from the interactive display. Each of the identified stroke inputs correspond to stroke data that at least partially overlap an enclosed area specified by a user via manipulation of a digitizer in erase mode.

### CROSS-REFERENCE TO RELATED APPLICATIONS

This application claims priority to U.S. Provisional Application No. 62/275,052 filed on Jan. 5, 2016. This application claims benefit to and is a continuation-in-part of U.S. patent application Ser. No. 15/173,275 filed on Jun. 3, 2016. U.S. Provisional Application No. 62/275,052 and U.S. patent application Ser. No. 15/173,275 are hereby incorporated by reference in their entirety.

### BACKGROUND

Flipcharts have not changed significantly over 100 years. And to this day it is very common for any meeting room to have some form of a flipchart for writing notes or sharing ideas. Use of the flipchart has been augmented by blackboards and/or whiteboards for presenting information. These tools continue to thrive in the office environment despite the introduction of digital projectors, interactive whiteboard displays, tablets, laptops, and mobile phone technology (collectively “interactive displays”). Whiteboards and flipcharts are advantageous because they are transparent to users, they are easy to set up and use, and have no technological barriers. Although technology has now advanced in the office environment, whiteboards and flipcharts are fundamentally unchanged.

### SUMMARY

In general, in one aspect, the invention relates to a method for updating an interactive display. The method includes detecting, by the interactive display, an eraser stroke input from a digitizer, converting the eraser stroke input into eraser stroke data, extrapolating an enclosed area based on the eraser stroke data, identifying at least one object group using the enclosed area, and updating the interactive display using the at least one object group.

In general, in one aspect, the invention relates to a non-transitory computer readable medium (CRM) comprising instructions, which when executed by a processor, performs a method. The method includes detecting, by an interactive display, an eraser stroke input from a digitizer, converting the eraser stroke input into eraser stroke data, extrapolating an enclosed area based on the eraser stroke data, identifying at least one object group using the enclosed area, and updating the interactive display using the at least one object group.

In general, in one aspect, the invention relates to a method for updating an interactive display. The method includes detecting, by the interactive display, an eraser stroke input from a digitizer, converting the eraser stroke input into eraser stroke data, extrapolating an enclosed area based on the eraser stroke data, identifying at least one stroke using the enclosed area, and updating the interactive display using the at least one stroke.

Other aspects of the invention will be apparent from the following description and the appended claims.

### BRIEF DESCRIPTION OF DRAWINGS

FIG. 1A shows a system in accordance with one or more embodiments of the invention.

FIG. 1B shows an apparatus in accordance with one or more embodiments of the invention.

FIGS. 2A-2C show varying perspectives of a digitizer for operating an electronic flipchart in accordance with one or more embodiments of the invention.

FIGS. 3A-3C show varying perspectives of a digitizer for operating an electronic flipchart in accordance with one or more embodiments of the invention.

FIG. 4 shows relationships in accordance with one or more embodiments of the invention.

FIG. 5 shows a flowchart describing a method for initializing a system in accordance with one or more embodiments of the invention.

FIG. 6 shows a flowchart describing a method for grouping stroke data in accordance with one or more embodiments of the invention.

FIG. 7 shows a flowchart describing a method for manipulating a grouping of stroke data in accordance with one or more embodiments of the invention.

FIGS. 8A-8E show examples of one or more of the method steps described in FIGS. 6-7 in accordance with one or more embodiments of the invention.

FIG. 9A shows a flowchart describing a method for updating an interactive display in accordance with one or more embodiments of the invention.

FIG. 9B shows a flowchart describing a method for identifying object groups relating to a set of stroke data in accordance with one or more embodiments of the invention.

FIG. 9C shows a flowchart describing a method for removing stroke inputs from an interactive display in accordance with one or more embodiments of the invention.

FIGS. 10A-10J show examples of one or more of the method steps described in FIGS. 9A-9C in accordance with one or more embodiments of the invention.

### DETAILED DESCRIPTION

Specific embodiments of the invention will now be described in detail with reference to the accompanying figures. Like elements in the various figures are denoted by like reference numerals for consistency. In the following detailed description of embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

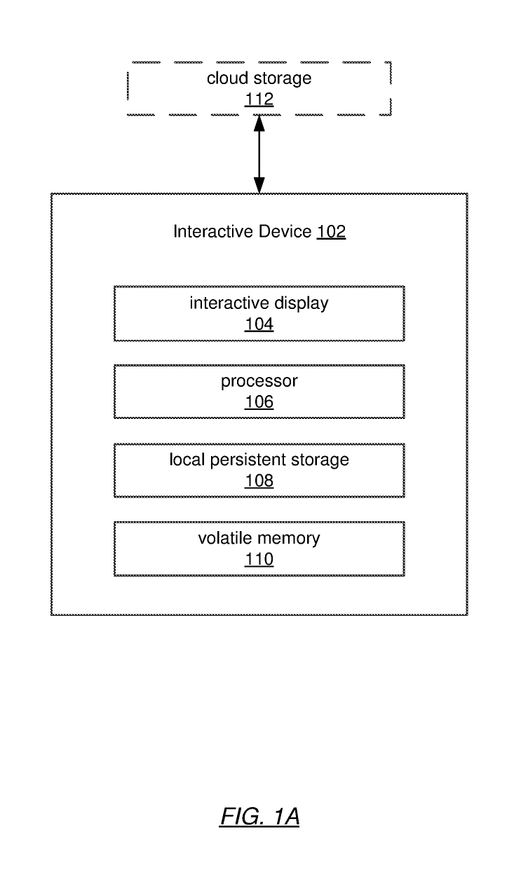

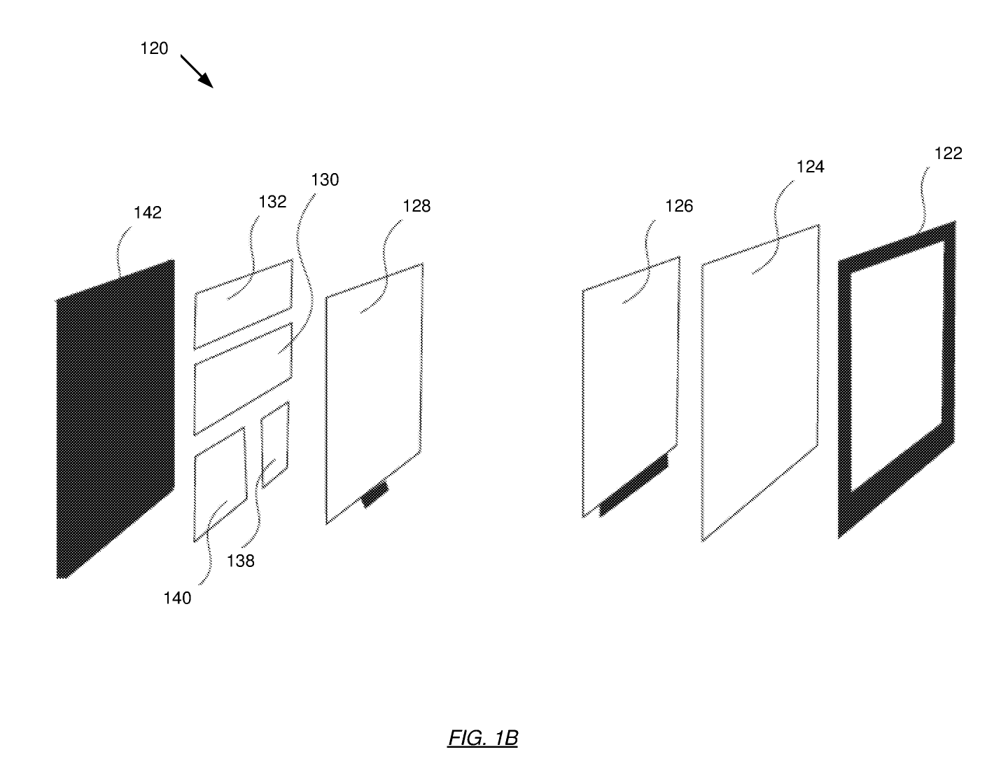

In the following description of FIGS. 1A-10J, any components described with regard to a figure, in various embodiments of the invention, may be equivalent to one or more like-named components described with regard to any other figure. For brevity, descriptions of these components will not be repeated with regard to each figure. Thus, each and every embodiment of the components of each figure is incorporated by reference and assumed to be optionally present within every other figure having one or more like-named components. Additionally, in accordance with various embodiments of the invention, any description of the components of a figure is to be interpreted as an optional embodiment which may be implemented in addition to, in conjunction with, or in place of the embodiments described with regard to a corresponding like-named component in any other figure.

In general, embodiments of the invention relate to a method and system for updating an interactive display on an interactive device. More specifically, embodiments of the invention are directed to the removal of identified stroke inputs from the interactive display. Each of the identified stroke inputs correspond to stroke data that at least partially overlap an enclosed area specified by a user via manipulation of a digitizer in erase mode.

FIG. 1A shows a system in accordance with one or more embodiments of the invention. The system includes an interactive device (102). Each component of the interactive device (102) is described below.

In one or more embodiments of the invention, the interactive device (102) is any physical system with an interactive display (104), a processor (106), local persistent storage (108), and volatile memory (110). Further, the interactive device (102) may be operatively connected to cloud (or remote) storage (112) in a cloud computing environment. In one or more embodiments of the invention, the interactive device (102) may be any interactive device capable of receiving input, such as a reflective display device, an interactive whiteboard, an electronic tablet, or any other suitable device. For example, the interactive device (102) may be an e-flipchart apparatus as described in FIG. 1B.

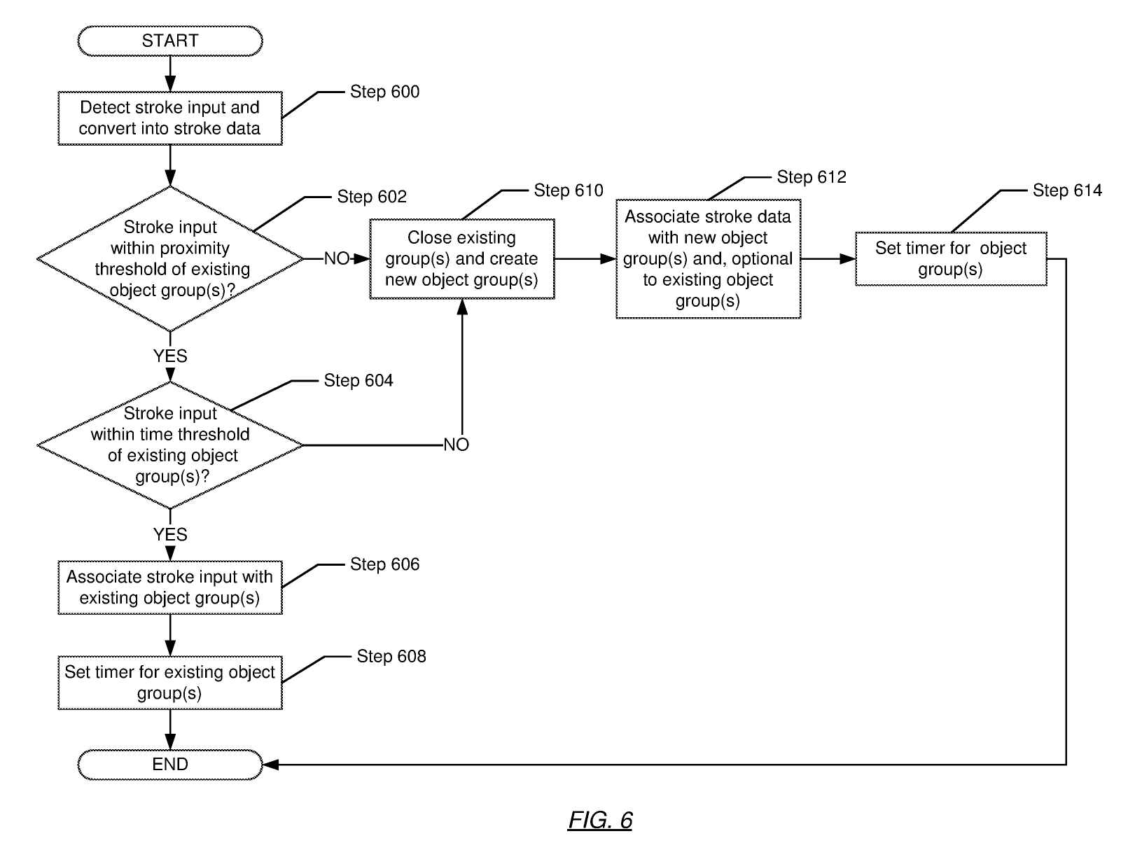

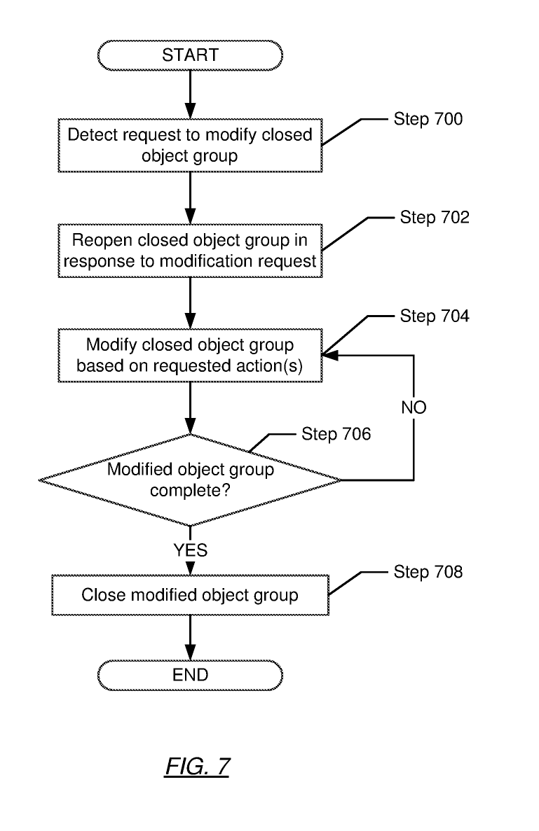

The interactive device (102) includes functionality to receive at least one stroke input (not shown) on the interactive display (104). The interactive device (102) also includes functionality to process, using the processor (106), the stroke input (described below) as stroke data (described below). Furthermore, the interactive device (102) is configured to categorize the stroke data based on an object type and to create object groups, using a proximity threshold and a time threshold, as further discussed below, and in accordance with the embodiments shown in FIG. 6. Additionally, the interactive device (102) is configured to store the stroke data in the volatile memory (110), local persistent storage (108), and/or cloud storage (112) associated with the interactive device (102).

In one or more embodiments of the invention, the interactive display (104) is a user interface with a display screen. The display screen may be a reflective Liquid Crystal Display (LCD), a bi-stable or electrophoretic display (e.g., electronic paper and/or electronic ink displays), an electrochromic display, an electro-wetting or electro-fluidic display, an interferometric modulated display (e.g., a technology that creates color via the interference of reflected light), and an electromechanical modulated display (e.g., a video projector, a flap display, a flip disk display, a digital micro-mirror device (DMD), an interferometric modulator display (IMOD), an uni-pixel display (FTIR), and a telescopic pixel display). In one or more embodiments, the interactive display (104) includes at least a touch-sensitive portion that is capable of receiving and displaying stroke input. In one or more embodiments of the invention, the stroke input, displayed by the interactive display (104), may be any digital pixel or marking made by touch input on the touch-sensitive portion of the interactive display (104), or by input on the interactive display (104) via a digital marker. For example, the stroke input may be a dot, a line, a letter, a drawing, a word, or a series of words made on the interactive display (104) using a digital marker, stylus pen, or user touch input.

As previously mentioned, in one or more embodiments of the invention, the stroke input is processed into stroke data, by the processor (106) and stored on the interactive device (102). The stroke data may be initially stored in the volatile memory (110), in accordance with the embodiments shown in FIG. 6. Volatile memory (110) may be any volatile memory including, but not limited to, Dynamic Random-Access Memory (DRAM), Synchronous DRAM, SDR SDRAM, and DDR SDRAM. Additionally, the interactive device (102) may store the stroke data in the local persistent storage (108) of the interactive device (102). Local persistent storage (108) may be, for example, solid state memory, optical storage, magnetic storage, or any other medium capable of persistently storing data. Further, the stroke data may optionally be stored on remote persistent storage or in a cloud computing environment having cloud storage (112), such as a web-based storage environment.

In one or more embodiments of the invention, the stroke data may include, but is not limited to, location data for the stroke (e.g., the x, y, coordinates of the detected locations of the stroke input), optional stroke pressure data for the stroke (e.g. the amount of pressure that was detected at each location point), stroke characteristics that can be used to render the stroke from the location data and optional pressure data (e.g. stroke line width, stroke type (e.g. pen, pencil, marker), stroke color), a timestamp associated with the stroke input, a user that produced the stroke (e.g., the user that used a stylus to draw a line on the interactive device), the type of input that was used to generate the stroke input (e.g., stylus, finger(s), etc.), information about the stylus (if a stylus was used) (e.g., the width of the tip of the stylus, etc.). In one or more embodiments of the invention, the stroke data may include the location of the pixels that are changed as a result of the stroke (e.g., the pixels that make up the line(s) and/or curve(s) that were created as a result of the stroke input).

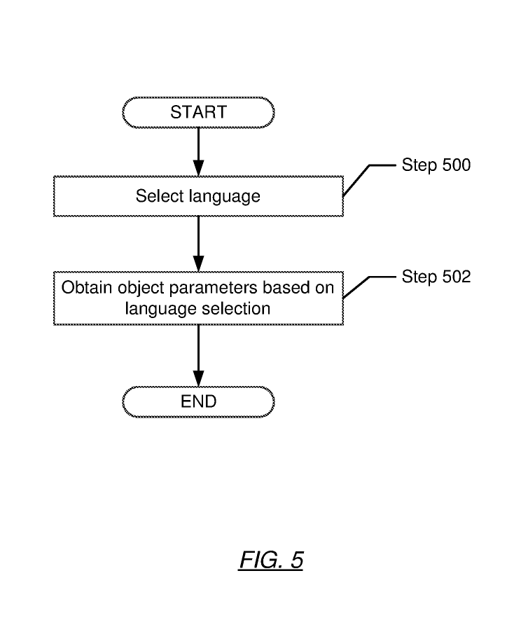

The interactive device shown in FIG. 1 A may include functionality to implement all or a portion of the methods shown in FIGS. 5-7 and 9A-9C. More specifically, the interactive device may include software instructions in the form of computer readable program code to perform all or a portion of the functionality described in FIGS. 5-7 and 9A-9C.

While FIG. 1A shows a configuration of components, system configurations other than those shown in FIG. 1A may be used without departing from the scope of the invention. For example, various components may be combined to create a single component. As another example, the functionality performed by a single component may be performed by two or more components.

FIG. 1B shows a schematic diagram of an apparatus of an e-flipchart (also referred to as an e-flipchart apparatus) in accordance with one or more embodiments of the invention. While FIG. 1B shows a configuration of components, other configurations may be used without departing from the scope of the invention. For example, various components may be combined to create a single component. As another example, the functionality performed by a single component may be performed by two or more components.

Turning to FIG. 1B, in accordance with one or more embodiments of the invention, the apparatus (120) may include one or more hardware elements, each having specific functionality. The main structure of the e-flipchart apparatus is formed between a back panel (142) and a front frame (122). In one or more embodiments of the invention, the front frame is a clear, opaque, or translucent material and includes an active area on which content may be displayed. In one or more embodiments of the invention, the back panel (142) is a rigid mechanical support structure made of a solid material, for example, plastic or metal. In between the back panel (142) and the front frame (122) is a low-power, reflective display (126). In one or more embodiments of the invention, the reflective display (126) may be viewed as an output device that, through reflection, harnesses ambient light in order to present content. For example, the reflective display (126) may host slow refresh rates, monochromatic coloring (e.g., black and white, or gray scale shading), and the presentation of low contrasting definition. However, on the other hand, the reflective display (126) may have one or more of the following features: (i) very low power consumption; (ii) the readability of content outdoors under sunlight; and (iii) the providing of strain relief on the eyes of a user. As such, in one or more embodiments of the invention, fundamental static digital media, such as monochromatic text and still images, may be delegated to a reflective display (126) for presentation. Examples of a reflective display include, but are not limited to, a reflective Liquid Crystal Display (LCD), a bi-stable or electrophoretic display (e.g., electronic paper and/or electronic ink displays), an electrochromic display, an electro-wetting or electro-fluidic display, an interferometric modulated display (e.g., a technology that creates color via the interference of reflected light), and an electromechanical modulated display (e.g., Flap Display, digital micro-mirror device).

In one or more embodiments of the invention, at least one portion of the reflective display (126) of the e-flipchart apparatus may be bi-stable. In one or more embodiments of the invention, the reflective display may correspond to the reflective displayed described in U.S. Pat. No. 5,930,026. The invention is not limited to the reflective display described in the above referenced patent.

Continuing with the discussion of FIG. 1B, in front of the reflective display (126) is a layer having at least one touch portion which may be a transparent rigid or semi-rigid board (124), or a frame that uses edge sensors, such as Infra-red or optical sensing technology. In another embodiment, the layer having at least one touch portion (124) may be a capacitive film layer. In one or more embodiments, the layer having at least one touch portion (124) may only cover a portion of the reflective display, with the remaining surface area of the reflective display (126) being covered by non-touch sensitive material which may or may not be clear, opaque, translucent, transparent and/or non-transparent. In the back of the reflective display (126) is an optional electromagnetic layer, which may be an electromagnetic board (128). By combining the electromagnetic layer (128) and the layer having at least one touch portion (124), at least a dual system for touch input is obtained. In one or more embodiments, touch input may include a finger(s) and/or a touch by a digital marker or digitizer.

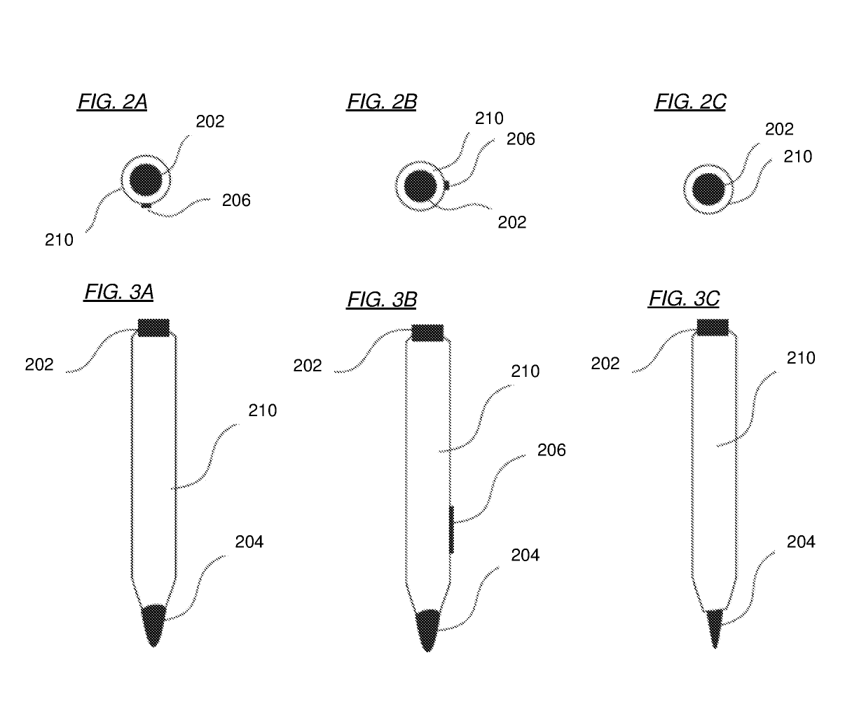

In one or more embodiments of the invention, the electromagnetic layer (128) is configured to generate an electromagnetic field capable of detecting a digital marker or digitizer (see e.g., FIGS. 2A-3C) when such a tool is used to provide an input to the e-flipchart. The electromagnetic layer (128) includes wires (not shown) that allow the electromagnetic layer (128) to transmit and detect input signals. In one or more embodiments of the invention, the electromagnetic board (128) is configured to determine a position of the touch input (described above) on the e-flipchart by detecting pressure or changes in the generated electromagnetic field caused by a designated portion of the touch input, for example, by the tip of a digital marker (or digitizer), electronic eraser, and/or pressure applied by one or more fingers.

In one or more embodiments of the invention, the front frame (122) includes an active area or region with an active display, and an active input method that includes at least two input capabilities: the ability to detect a digital marker or digitizer and the ability to accept touch input from one or more finger touch points. Further, the apparatus (120) is configured to respond to each detected input type. For example, detecting a digital marker input may result in a line being drawn on or erased from the reflective display, while touching the same area with a finger may pan or zoom the display area.

Continuing with FIG. 1B, controller (132) includes hardware and software/firmware to control the overall operation of the e-flipchart. More specifically, the controller (132) may include one or more processors (CPUs), persistent storage, and/or volatile memory. Persistent storage may include, for example, magnetic storage, optical storage, solid state storage (e.g., NAND Flash, NOR Flash, etc.), or any combination thereof. Volatile memory may include RAM, DRAM, or any combination thereof. In one or more embodiments of the invention, all or a portion of the persistent storage and/or volatile memory may be removable. In one or more embodiments, the persistent storage may include software instructions for executing operations of the e-flipchart. Specifically, the persistent storage may be configured to store software and/or firmware specific to e-flipchart operations. In one or more embodiments of the invention, the built-in CPU/processors of the controller (132) may execute an operating system and the software which implements e-flipchart functionality.

The controller (including components therein) (132) is powered by a battery and/or a power supply (130). In one or more embodiments, controller (132) is configured to detect and process input signals. For example, when an object touches the layer having at least one touch portion (124), a signal is sent to the controller (132) for detection of the input type and processing of the input. Further, the controller is configured to store e.g., in persistent storage and/or volatile memory, each stroke (in the form of touch input or digital marker) after such an action is performed on the e-flipchart (120). In other words, the controller (132) is configured to store each stroke or action as it is produced in the active area of the front frame (122) of the e-flipchart apparatus (120). Further, while the controller (132) has been described as a combination of hardware and software, the controller may be implemented entirely within hardware without departing from the scope of the invention.

In one or more embodiments of the invention, the e-flipchart may include one or more external communication interfaces (138). The communication interfaces permit the e-flipchart to interface with external components. The communication interfaces may implement any communication protocol, for example, Bluetooth, IEEE 802.11, USB, etc. The invention is not limited to the aforementioned communication protocols.

In one or more embodiments of the invention, the apparatus (120) of FIG. 1B is a lower-power reflective device that only draws power from the battery/power supply (130) when there is a screen refresh with new information displayed or when a user is drawing or inputting information in the apparatus. In other words, while the apparatus (120) is “always on” and in a mode that is ready to detect an input, the apparatus is in a low power state. When an input is detected by the apparatus (120) on the active area of the front frame (122), the e-flipchart apparatus is configured to change from the low power state to an active state.

In one or more embodiments of the invention, the e-flipchart apparatus may be deemed to be in an active state when some or all the components on the e-flipchart apparatus are working accepting pen, touch, keyboard and LAN input, processing applications and/or saving data (and/or metadata) to memory. In the active state, the components of the e-flipchart apparatus are drawing energy from the controller (132). In contrast, the e-flipchart apparatus may be deemed to be in a low power state, (or ready-mode) when no pen, touch, keyboard or LAN inputs are detected (for at least a pre-determined period of time), but the apparatus still shows the last content displayed on it (or displays no content). In ready-mode, CPU processes are minimized, scan rate of finger and pen inputs are delayed and overall power consumption of the components in the e-flipchart apparatus are reduced, for example, by at least 50%. Power consumption may be reduced by a different amount without departing from the invention. For example, only the battery and the controller may be drawing power in ready-mode, reducing the overall power consumption of the e-flipchart apparatus to 40% relative to the power consumption of the e-flipchart apparatus when it is in the active mode. The management of the amount of power that is provided to components of the e-flipchart apparatus and the frequency of polling for input is performed by the controller (132). Specifically, the controller (132) may include an energy management process configured to control the state of various components of the e-flipchart apparatus based on whether the e-flipchart apparatus is in ready-mode or in the active mode.

To contrast the two states of the e-flipchart apparatus, in one or more embodiments of the invention, when the reflective display is in ready-mode, the polling for input occurs at a low frequency, for example, the apparatus may scan for input 2-10 times per second. However, once an input is detected by the apparatus, the apparatus may transition to an active state and increase polling to a higher frequency, e.g., 60-120 times per second, in order to capture all the input that may be occurring on the reflective display. Other polling frequencies may be used in the active state and/or in the ready-mode without departing from the invention.

In one or more embodiments of the invention, the term “low power state” is intended to convey that the power consumption of the e-flipchart apparatus in this state is relatively lower (or less) than the power consumption of the e-flipchart apparatus in the active state.

Though not shown in FIG. 1B, the e-flipchart apparatus may include a camera for detecting certain types of input, e.g., a gesture interpretation. In one or more embodiments of the invention, the e-flipchart is configured to enable a user to create, modify, store, and share an e-presentation.

In one or more embodiments of the invention, the apparatus (120) of FIG. 1B is approximately 42 inches in diagonal with a 3:4 aspect ratio. Those skilled in the art will appreciate that the size of the e-flipchart apparatus is designed to mimic that of a typical paper flipchart; however, the dimensions and size of the reflective display apparatus of FIG. 1B may vary without departing from the scope of the invention. For example, additional dimensions may include 32″ 4:3 aspect ratio for a personal sized flip chart, and 55″ or 60″ for larger collaborative surfaces. Even larger surfaces may vary the aspect ratio to allow for more usable width, without adding unusable height, such as a 9:16 ratio for an 80″ diagonal size.

While FIG. 1B describes an e-flipchart with a series of components organized in particular manner, those skilled in the art will appreciate that the location of such various components in the e-flipchart, in particular, the reflective display (126), the layer having at least one touch portion (124), and the optional electromagnetic layer (128) may be arranged in different order without departing from the invention.

FIGS. 2A-2C shows the hardware for the digital marker or digitizer that may be used as one type of input capable of being detected by the e-flipchart apparatus described in FIG. 1B above. Specifically, FIGS. 2A-2C show a top view of the digital marker in the form of a cylinder (210). The top of the digital marker has an electronic eraser (202) and at least one button (206). In one or more embodiments of the invention, the button (206) is software programmable and, when pressed or otherwise activated, is configured to send one or more signals to the e-flipchart. For example, when the button (206) is pressed or otherwise activated, the button (206) may send a wireless signal that is detected by the e-flipchart. Those skilled in the art will appreciate that the button (206) may be hidden or built into the electronic eraser (202). Further, although only one button is shown in FIG. 2A-2C, the digital marker may include more than one button, where each button is separately programmable.

In one or more embodiments, when the electronic eraser (202) comes into contact with the e-flipchart, the e-flipchart is configured to remove or otherwise clear content from the corresponding locations on the reflective display (e.g., thereby enabling or entering an erase mode). Said another way, the electronic eraser (202) mimics the operation of a traditional eraser. In another embodiment of the invention, a button (206) on the digitizer may be programmed to enable the erase mode. Further, the corresponding locations on the reflective display from which content may be removed may be designated by eraser stroke inputs performed by a user handling the digitizer. In one or more embodiments of the invention, an eraser stroke input may be substantively similar to a stroke input (e.g., a dot, a line, a letter, a drawing, a word, or a series of words made on the interactive display (104) using a digital marker, stylus pen, or user touch input), however, instead of producing content on the reflective display, an eraser stroke input removes content at least partially overlapping the eraser stroke inputs. In one or more embodiments of the invention, the corresponding locations on the reflective display from which content may be removed may be referred to as an enclosed area.

FIG. 2B shows a different orientation (i.e., a side view with a zero degree rotation of the cylinder) of the digital marker or digitizer, in which the button (206) is located at the side of the electronic eraser (202) rather than at the bottom of the electronic eraser (202). FIG. 2C shows another top view of the digital marker, in which the cylinder is rotated 90 degrees. In FIG. 2C, the button (not shown) is hidden from view.

FIGS. 3A-3C depict side views of the digital marker or digitizer in accordance with one or more embodiments of the invention. In FIGS. 3A-3C, the entire length of the cylinder (210) form of the digital marker can be seen. In FIG. 3A, on a top end of the digital marker, the electronic eraser (202) is shown. In addition, the tip (204) of the digital marker or digitizer is shown on a bottom end of the cylinder (210). The tip (204) material may be selected such that the tip (204) slides easily over the writing surface. Materials for the tip (204) may include, but are not limited to, high density polyoxyethylene, hard felt, elastomer, polyoxymethylene, polyacetal, or polyoxyethylene. Other materials may be used without departing from the invention.

In one or more embodiments of the invention, the tip (204) of the digital marker may be used to draw or write directly on the active area of the front frame (102) of the e-flipchart apparatus. In FIG. 3B, the button (206) is shown on a side of the cylinder (210) of the digital marker. In FIG. 3C, the tip (204) of the digital marker is shown as being thinner and sharper in comparison with the tip of FIGS. 3A-3B. Those of ordinary skill in the art will appreciate that the tip (204) of the digital marker is a hardware component that may be interchangeable and designed to mimic a pencil, pen, marker, stylus, or any other suitable writing tool having varying widths and sharpness. In FIG. 3C, the button is not shown.

While FIG. 3A-3C show a cylinder shape for the digital marker, those skilled in the art will appreciate that the shape of the digital markers may take other forms without departing from the scope of the invention.

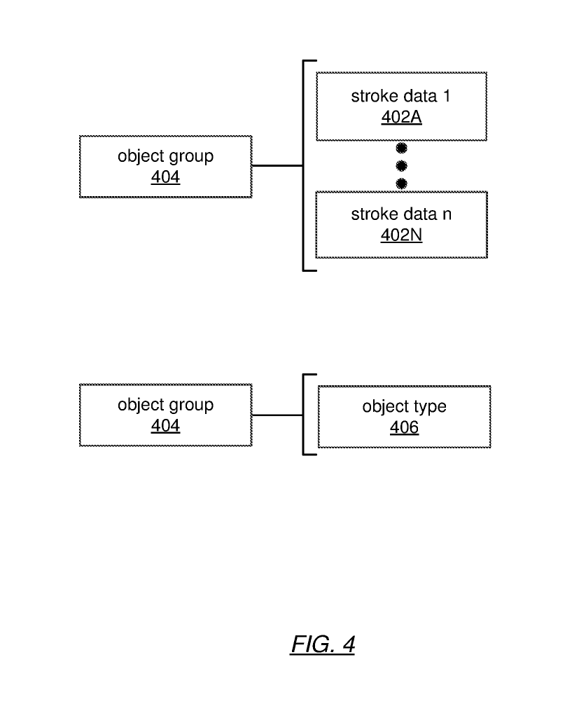

FIG. 4 shows relationships in accordance with one or more embodiments of the invention. Specifically, FIG. 4 shows the relationship between stroke data (402A, 402N) and an object group (404) and the relationship between an object group (404) and an object type (406). Each of these relationships is described below.

As previously discussed, in one or more embodiments of the invention, stroke data (402) is data pertaining to the stroke input (e.g., a dot, a line, a letter, a drawing, a word, or a series of words) made on the interactive display (104), using a digital marker, stylus pen, or user touch input.

In one or more embodiments of the invention, the object group (404) is a logical grouping of a particular set of stroke data. For example, an object group (404) may include all of the stroke data that make up a letter, a word, a phrase, a sentence, or a paragraph.

In one or more embodiments of the invention, the stroke data that is associated with an object group (404) may be determined using, for example, time and proximity parameters as described below. FIG. 4 shows an object group (404) that includes stroke data 1 (402A) through stroke data n (402N) (“stroke data 1-n”), which is related to stroke input 1 through stroke input n (“stroke inputs 1-n”). In one or more embodiments of the invention, stroke inputs 1-n may be any range or group of associated stroke input that the interactive device (104) receives. For example, stroke inputs 1-4 may include four separate strokes (e.g., four parallel lines) or four groups of strokes (e.g., four letters). Further, the object group (404) encompassing stroke data 1-n may include a cumulative aggregation of all of the stroke data (402) of stroke inputs 1-n. Alternatively, the object group (404) encompassing stroke data 1-n may only include a selective aggregation of the stroke data (402A, 402N) of stroke inputs 1-n, based on the continuous classification and re-classification of the strokes as particular object types (406) (discussed below). For example, if a user draws a letter, stroke data 1-n may relate to each and every individual stroke data for the letter. As another example, if a user is in the process of writing a sentence, stroke data 1-n may relate only to the last completed word or letter of the sentence. Thus, the granularity of the stroke data in an object group may vary depending on the object group that the user wishes to define.

In one or more embodiments of the invention, a particular object group (404) may be associated with an object type (406). In one or more embodiments of the invention, the object type (406) may be a letter, a word, a sentence or a paragraph. Those skilled in the art will appreciate that the invention is not limited to the aforementioned object types.

In one or more embodiments of the invention, each individual piece of stroke data (402A, 402N) may be associated with one or more object groups, where each object group is associated with an object type. For example, consider a scenario in which a user wrote the phrase “Hello World” on an interactive display and that there are three object types: letter, word, and sentence. In this example, the stroke data corresponding to the letter “H” is associated with: (i) an object group of object type letter that is associated with all stroke data for letter “H”, (ii) an object group of object type word associated with all stroke data corresponding to the word “Hello”; and (iii) an object group of object type sentence associated with all stroke data corresponding to the words “Hello World.” In this manner, the stroke data is associated with a set of nested object groups, where each object group has a different level of granularity.

In one or more embodiments of the invention, each object group is associated with a state. The object group may be in an “open” state or in a “closed state.” When an object group is in an “open” state, additional stroke data may be associated with the object group. When an object group is in a “closed” state, additional stroke data may not be associated with the object group.

In one or more embodiments of the invention, each user may only have one open object group per object type at any given time. For example, a given user may only be associated with one open object group for each of the following types at any one time—letter, word, and sentence. Accordingly, if there are multiple users using the interactive device, then each user may have its own open set of object groups.

Those skilled in the art will appreciate that the use of certain parameters that take into consideration both the time and proximity of the stroke input (time and proximity thresholds), allow the stroke input to be classified into object groups in a manner that is consistent with written language norms. By identifying and differentiating between object types in the embodiments described above, the invention facilitates certain formatting and manipulation functions of the stroke input, without the need to first convert the digital drawings and handwriting into corresponding ASCII, Unicode or other word processor-friendly text.

FIGS. 5-7 show flowcharts in accordance with one or more embodiments of the invention. More specifically, FIGS. 5-7 describe methods for categorizing and grouping stroke data in accordance with one or more embodiments of the invention. While the various steps in each flowchart are presented and described sequentially, one of ordinary skill in the art will appreciate that some or all of the steps may be executed in different orders, may be combined or omitted, and/or may be executed in parallel. In one or more embodiments of the invention, one or more steps shown in FIGS. 5-7 may be performed in parallel with one or more other steps shown in FIGS. 5-7. Furthermore, the steps may be performed actively or passively. For example, some steps may be performed using polling or be interrupt driven in accordance with one or more embodiments of the invention.

FIG. 5 shows a flowchart for initial system setup in accordance with one or more embodiments of the invention. In step 500, the interactive device detects the selection of a particular language to be used by the system, such as English, Arabic, or Mandarin Chinese. As previously mentioned, the language selection may be used to facilitate the classification and grouping of the stroke input into object groups, based on the stroke data and object type(s) of the stroke input. In step 502, the interactive device obtains certain parameters to be used by the system, based on the language selection. Those parameters may include, for example, various time and distance thresholds corresponding with the general written language conventions of the selected language. For example, the language selection may determine the spacing between characters (e.g., proportional to the average character size of the text written in the board), the direction that the text is read, etc.

FIG. 6 shows a flowchart for grouping stroke input in accordance with one or more embodiments of the invention. More specifically, FIG. 6 shows how certain stroke input is grouped into either a new or an existing object group(s).

In step 600, stroke input is detected on the interactive display. The stroke input is then converted into stroke data.

In step 602, a determination is made as to whether the stroke input is within a proximity threshold of an existing object group(s). In one or more embodiments of the invention, there may be one or more object groups that are currently in an “open” state (discussed above). The determination related to whether the stroke input (as defined by the stroke data) is within a proximity threshold may be performed on a per object group basis (if more than one object group is in an “open” state) or may be performed for only one object group of the set of object groups that are currently in an “open” state. As discussed above, the object groups may be associated with a user. In such instances, the determination in step 602 is only performed on object groups associated with the user that provided the stroke input to generate the stroke data in step 600.

In one or more embodiments of the invention, a proximity threshold is a requisite proximity value, based on a distance of the stroke input (as defined in stroke data) in relation to the distance of existing stroke input (as defined by corresponding stroke data) associated with an object group. There may be multiple proximity thresholds, which may be based on, among other things, the object type of the existing object group. As previously discussed, an object type is a logical subgrouping of a particular set of stroke input, which may be categorized as a marking, a stroke, a letter, a word, a sentence or a paragraph. An example of multiple proximity thresholds based on object types may include a first requisite proximity value associated with letters, a second requisite proximity value associated with words, a third requisite proximity value associated with sentences, etc. Additionally, one or more proximity thresholds may be defined during the initialization phase based on the selected language, as discussed above and in accordance with the embodiments in FIG. 5. Further, one or more proximity thresholds may be dynamically defined based on certain user-dependent stroke data, such as the average size of the user's handwriting when drawing the strokes.

Continuing with step 602, if the stroke input is determined to be within the proximity threshold of the existing object group(s), then step 604 is performed. In step 604, a determination is made as to whether the stroke input (as defined by the stroke data) is within a time threshold of an existing object group(s). In one or more embodiments of the invention, the determination of whether stroke data is associated with a given object group may be based solely on the proximity threshold. In such instances, step 604 is not performed.

In one or more embodiments of the invention, there may be one or more object groups that are currently in an “open” state (discussed above). The determination related to whether the stroke input is within a time threshold may be performed on a per object group basis (if more than one object group is in an “open” state) or may be performed for only one object group of the set of object groups that are currently in an “open” state. As discussed above, the object groups may be associated with a user. In such instances, the determination in step 604 is only performed on object groups associated with the user that provided the stroke input to generate the stroke data in step 600.

In one or more embodiments of the invention, a time threshold is a requisite time value, based on an amount of time elapsed between when the current stroke input was drawn (as defined by stroke data) and when the existing stroke input was drawn, enabling the current stroke input to be grouped into the same object group as the existing stroke input. As with the proximity threshold, there may be multiple time thresholds, which may be based on, among other things, the object type of the stroke input of the existing group or the selected language, as discussed above. Additionally, one or more time thresholds may be statically defined during the initialization phase, or dynamically defined based on certain user-dependent stroke data, such as the average time it takes a user to create certain stroke inputs.

Continuing with step 604, if the stroke input is determined to be within the time threshold of the existing object group(s), after it has also been determined to be within the proximity threshold, then step 606 is performed.

In step 606, the stroke data is associated with the existing object group(s) that is currently in an “open” state. An object group may remain in an “open” state as long as the requisite proximity and time thresholds of the object group are met. Otherwise, the object group will be transitioned to a “closed” state. As discussed below, a closed object group may be reopened in accordance with the embodiments of FIG. 7. In one or more embodiments of the invention, if there are multiple object groups in an “open” state then the stroke data may be associated with multiple object groups. For example, consider a scenario in which the user has written the following on an interactive device “Wor” and then subsequently writes the stroke data corresponding to the letter “l”. In this scenario, the stroke data corresponding to letter “l” may be associated with an object group of object type letter (which may be created using step 610, discussed below), an object group of object type word (which also includes stroke data corresponding to the “W”, “o”, and “r”) and an object group of object type sentence (which also includes stroke data corresponding to “W”, “o”, and “r”).

In step 608, upon associating the stroke data with the existing open object group(s), the timer(s) for the existing open object group(s) is set. In one or more embodiments of the invention, the timer(s) for the existing object group is used in determining whether the existing object group should continue to remain open or be closed. To make this determination, the timer(s) takes into consideration the relevant stroke data, object type(s) and time and proximity thresholds associated with the object group. After the timer expires for an existing object group, the object group is closed. If there are multiple open object groups (i.e., object groups with a state of “open”), then there may be a separate timer for each of the object groups. Further, the duration of the timer for each of the object groups may be the same or different. For example, the object group of object type word may have a shorter timer than an object group of object type sentence.

Turning back to step 602, where a determination is made as to whether the stroke input (as defined by the stroke data) is within a requisite proximity threshold of an existing object group(s), if the stroke input is not within the requisite proximity threshold, then the stroke input is not added to the existing group(s). That is, when the current stroke input is detected too far away from the existing stroke previously made, even if the current stroke input is made within a required time threshold, the current stroke input is not added to the existing open group. Instead, the existing group is closed and the process moves to step 610.

In one or more embodiments of the invention, if there are multiple open object groups then the determination in step 602 is performed on a per object group basis and only open object groups for which the proximity threshold is exceed are closed.

For example, consider a scenario in which the user has written the following on an interactive device “Hello” and then the user writes a first stroke corresponding to a portion of the letter “W.” Further assume that the distance between the first stroke corresponding to the letter “W” and the letter “o” is: (i) greater than a proximity threshold for an object group of object type letter, (ii) greater than a proximity threshold for an object group of object type word, and (iii) less than a proximity threshold for an object group of object type sentence. In this example, the object group of object type letter and the object group of object type word are closed but the object group of object type sentence remains open.

Continuing with the discussion of FIG. 6, in step 610, a new object group(s) is created to accommodate the current stroke input (or, more specifically, the stroke data associated with the current stroke input). Step 610 may include creating one or more new object groups. For example, consider a scenario in which the user has written the following on an interactive device: “Hello” and the current stroke input is a first stroke corresponding to a portion of the letter “W.” Further assume that the distance between the first stroke corresponding to the letter “W” and the letter “o” is: (i) greater than a proximity threshold for an object group of object type letter, (ii) greater than a proximity threshold for an object group of object type word, and (iii) less than a proximity threshold for an object group of object type sentence. In this example, an object group of object type letter and the object group of object type word are closed but the object group of object type sentence remains open. Further, in step 610, a new object of object type letter and a new object of object type word are created.

In step 612, the stroke data is associated with the new object group(s). As with the previous discussion of step 608, upon associating the stroke data with the new open object group. Continuing with the example described in Step 610, the stroke data is associated with the new object of object type letter, the new object of object type word, and an existing object of object type sentence. In step 614, the timer(s) for the new open object group(s) is set. The new object group(s) remains open as long as the timer does not expire. Further, in step 614 if there are also existing object groups with which the stroke data is associated, then the timers associated with the existing object groups are also set. Continuing with the example described in Step 612, a timer is set for the new object of object type letter, for the new object of object type word, and for an existing object of object type sentence.

FIG. 7 shows a flowchart for manipulating a grouping of stroke data in accordance with one or more embodiments of the invention. More specifically, FIG. 7 shows how a closed object group may be reopened and modified to include new stroke input. As discussed above, a closed object group is an object group that has been finalized and is closed to the inclusion of subsequent stroke input. An object group may remain open as long as the requisite proximity and time thresholds of the object group are met, thereby preventing the expiration of the object group's timer. Upon the expiration of the object group's timer, the object group will be closed.

In step 700, a request to modify a closed object group is detected. The request may be sent as a result of a user selecting the closed object group, using the selection tools of the interactive device. For example, the user may select an area corresponding to the closed object group by using a finger (touch input) or a digital marker to draw a circle around the area. Once the desired object group has been selected, the user can reactivate the closed object group by selecting the appropriate button or prompt on the interactive display.

In step 702, the closed object group is reopened in response to the modification request. Upon reactivating the closed object group in step 700, the closed object group is reopened and all other object groups are closed. The user may then request to modify certain elements of the reactivated group, as further discussed below.

In step 704, the closed object group is modified based on the requested modification action. A requested modification action may include reformatting the group, removing or modifying stroke input within the object group, or adding new stroke input to the object group. For example, reformatting the object group may include, among other things, resizing an area of the object group, and modifying the structure of the object group to re-accommodate the stroke input after the area is resized. As another example, removing or modifying stroke input may include completely erasing certain stroke data within the object group, or making certain changes to the stroke input, such as changing the spelling of a word or adding a punctuation marks. Further, when a user reopens a previously closed object group, subsequent stroke data may be added to the existing object group.

In step 706, a determination is made as to whether the modified object group is complete. In one or more embodiments of the invention, the modified object group is complete when modification actions should no longer be executed within the modified object group. The determination of whether the modified object group is complete may be made in response to the user selecting a certain prompt to indicate that the modified object group is complete. Additionally, in the absence of the user indicating that the modified object group is complete, the determination may be made based on a timer of the modified object group. The timer is used to determine whether subsequent stroke input or modification actions are made within the requisite proximity and time thresholds associated with the modified object group. In step 706, if the modified object group is not complete, then any subsequent modification actions will continue to be executed within the modified object group, until the modified object group is complete. In step 708, upon the completion of the modified object group, the modified object group is closed and any subsequent modifications are not included within the modified object group.

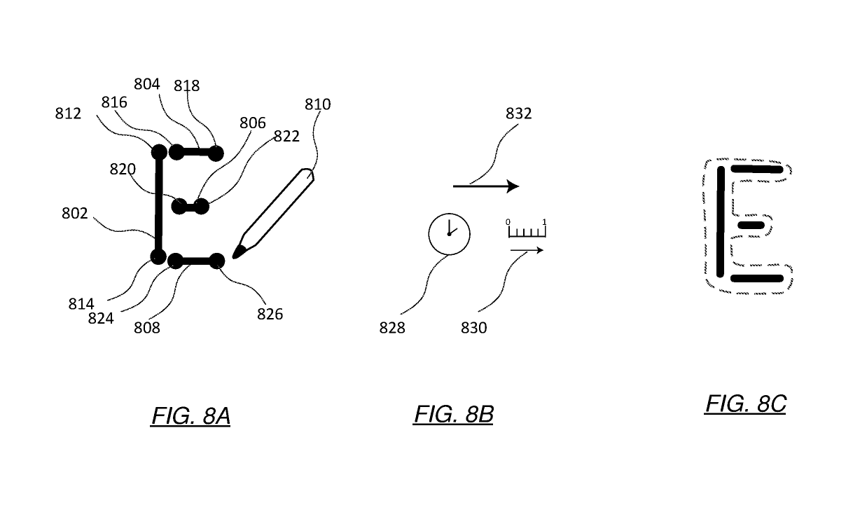

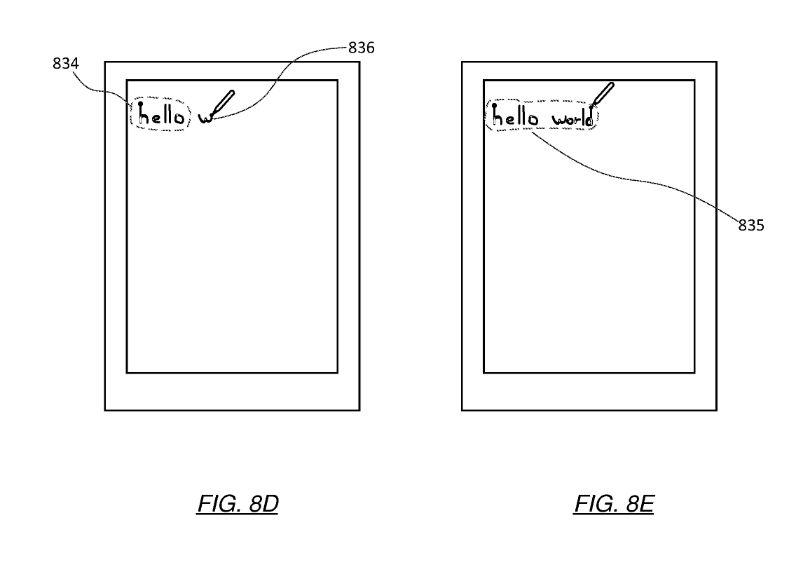

FIGS. 8A-E show examples of one or more of the method steps described in FIGS. 6-7, in accordance with one or more embodiments of the invention.

FIGS. 8A-8C illustrates how certain stroke data is derived from stroke input drawn on an interactive device. Specifically, FIG. 8A provides an illustration of the strokes comprising an uppercase letter “E”, drawn on an interactive display using a digital marker (810), and the start/end points of the strokes. In this example, the letter E is comprised of four separate strokes (802, 804, 806, 808), each of which has a corresponding starting point and ending point. The first stroke (802) is a vertical line with starting point 812 and ending point 814. The second stroke (804) is a horizontal line with starting point 816 and ending point 818. The third stroke (806) is a horizontal line with starting point 820 and ending point 822. The fourth stroke (808) is a horizontal line with starting point 824 and ending point 826.

Turning to FIG. 8B, FIG. 8B illustrates how the four strokes in FIG. 8A are grouped as a single object, based on certain predetermined parameters. In this example, the predetermined parameters take into consideration the proximity of the start or end point of a stroke, in relation to subsequent strokes (requisite proximity) (830). The predetermined parameters also take into consideration the amount of time elapsed between each stroke (requisite time) (828). If the stroke input meets both the proximity and time elements of the predetermined parameters, then it is grouped as a single object (832).

Turning back to FIG. 8A and using the logic of FIG. 8B, if the starting point (816) of the second stroke (804) is drawn within the requisite time (828) and requisite proximity (830) of the first stroke (802), then both strokes are grouped as a single object. Similarly, if the third stroke is drawn within the requisite time and proximity of the second stroke, and the fourth stroke is drawn within the requisite time and proximity of the third stroke, then all four strokes are grouped as a single object, as illustrated in FIG. 8C. In doing so, the strokes are now categorized as a letter (“E”), as opposed to four separate strokes.

FIGS. 8D-8E further expand on the concept illustrated in FIGS. 8A-8C. FIG. 8D shows an object group comprising the word “hello” (834) and the letter “w”(836). The word “hello” (834) consists of a first group of letters that are drawn within the requisite time and proximity parameters to be associated with an object group of object type word. As such, the first group of letters is associated with an object group of object type word. In contrast, the letter “w”(836) is outside of the requisite proximity parameters associated with the object group of object type word, and is therefore not included as a part of the object group. However, the letter “w” (836) may still be included in the existing object group (834) if it is drawn within the requisite time and proximity parameters of the existing object group (834), as shown in FIG. 8E and discussed below.

FIG. 8E shows the existing object group from FIG. 8D, which now comprises the words “hello” and “world” (834). As discussed above, “hello” consists of the first group of letters, which are associated with an object group of object type word. Further, “world” consists of a second group of letters, which are associated with a second object group of object type word. Additionally, the second word is drawn within the requisite time and proximity parameters of the existing object group, based on the relationship between the ending point of a stroke of the first word and the starting point of a subsequent stroke of the second word. As such, the stroke data associated with the object group for “world” and the stroke data associated with the object group for “hello” may also be associated with an object group of object type sentence (835).

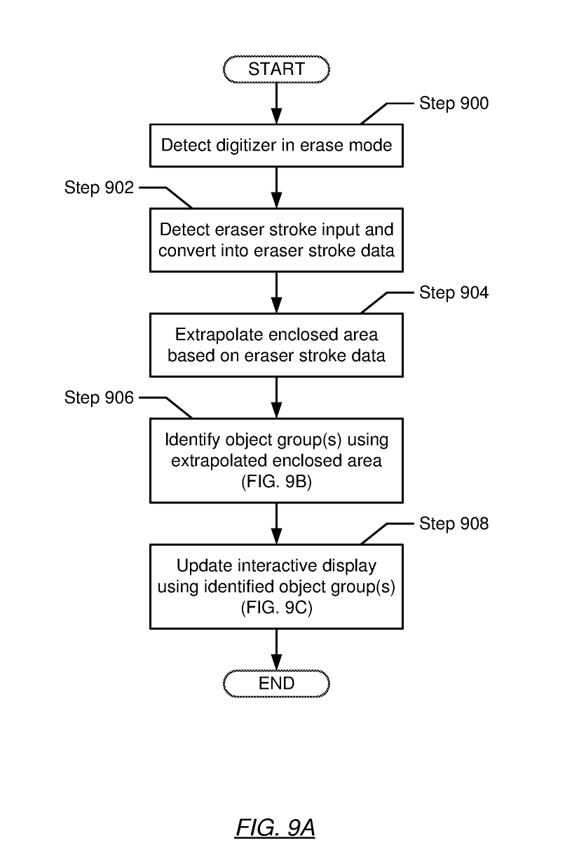

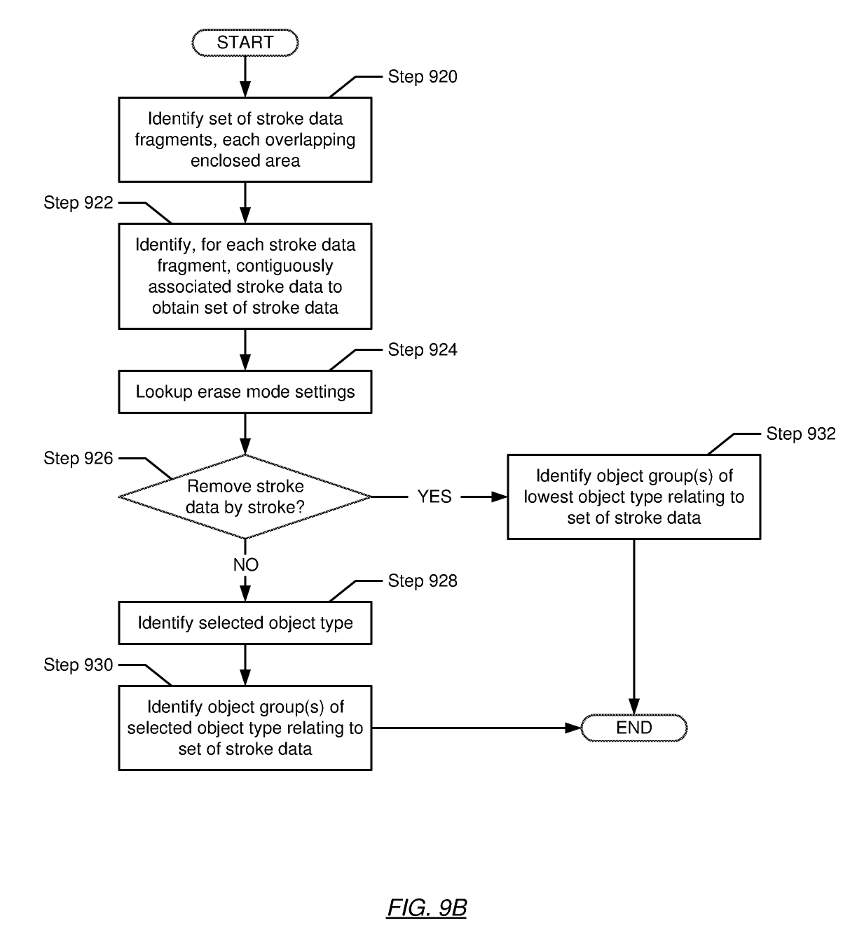

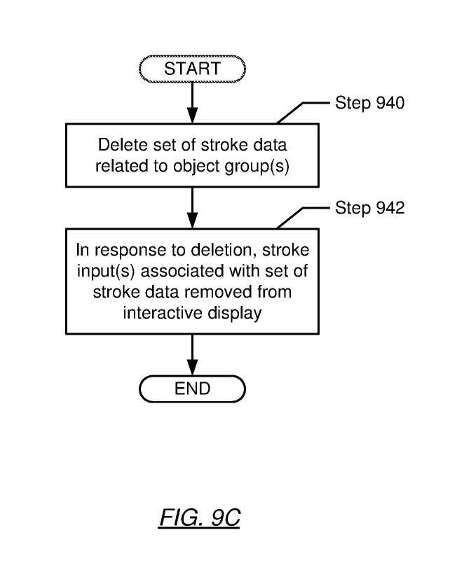

FIG. 9A shows a flowchart describing a method for updating an interactive display in accordance with one or more embodiments of the invention. In Step 900, a digitizer (e.g., an electronic pen, a digital marker, a stylus, etc.) is detected in erase mode. In one or more embodiments of the invention, a digitizer may be in erase mode when the electronic eraser (see e.g., 202 in FIGS. 2A-3C) on the digitizer is touching or proximal to the interactive display. The electronic eraser may be deemed to be proximal to the interactive display when the interactive display can detect the electronic erase in order to perform the steps shown in FIGS. 9A-9C. The specific distance between the electronic eraser and the interactive display for the electronic eraser to be consider proximal to the interactive display may vary based on the implementation of the digitizer and the interactive display. In one or more embodiments of the invention, the electronic eraser may be deemed to be proximal to the interactive board when the electronic eraser is closer to surface of the interactive display than the tip of the digitizer. In another embodiment of the invention, a digitizer may be in erase mode when a button on the digitizer is activated, wherein the button may be programmed to enable or enter erase mode when engaged by a user handling the digitizer. In one or more embodiments of the invention, while in erase mode, a user may select corresponding locations (e.g., enclosed areas (discussed below)) on the interactive display from which content may be removed or cleared.

In Step 902, one or more eraser stroke inputs are detected and converted into eraser stroke data. In one or more embodiments of the invention, an eraser stroke input may be substantially similar to a stroke input except instead of generating content on an interactive (or reflective display), an eraser stroke input enables a user of the digitizer to select and remove or clear content from the interactive display. In one or more embodiments of the invention, eraser stroke data may be created and stored in a manner substantially similar to stroke input (discussed above), however, eraser stroke data references data associated with one or more eraser stroke inputs.

In Step 904, an enclosed area is extrapolated based on the eraser stroke data (converted from the one or more eraser stroke inputs detected in Step 902). In one or more embodiments of the invention, an enclosed area may correspond to an area selected, by a user, on the interactive display from which content is to be removed or cleared. In one or more embodiments of the invention, the enclosed area may be extrapolated based on, for example, the location data (e.g., the x, y coordinates of the detected locations of the eraser stroke input) of the corresponding eraser stroke data. In one or more embodiments of the invention, the enclosed area may be any free-form shape (e.g., a shape having any irregular contour). In another embodiment of the invention, the enclosed area may be any geometric shape (e.g., circle, square, rectangle, triangle, etc.). Further, in the aforementioned free-form shape embodiment, the enclosed area may be incomplete, thereby meaning that no or zero points (or pixels) of the free-form shape intersect. In such an embodiment, a connection or extension may be extrapolated from, for example, a starting and ending point of an eraser stroke input (or corresponding eraser stroke data) to complete the free-form shape. The extrapolation may employ any existing area and/or data extrapolation techniques.

In Step 906, one or more object groups are identified using the enclosed area. More specifically, in one or more embodiments of the invention, one or more object groups relating to stroke data at least partially overlapping the enclosed area on the interactive display are identified. Further details elaborating Step 906 are discussed below with respect to FIG. 9B.

In one or more embodiments of the invention, alternative to identifying one or more object groups, in Step 906, one or more strokes not affiliated with an object group are identified using the enclosed area instead. In one or more embodiments of the invention, the one or more strokes may encompass a subset (e.g., a portion or all) of a collection of strokes grouped to represent, for example, a drawing, a doodle, or an image, rather than an object group. To that end, more specifically, in one or more embodiments of the invention, one or more strokes relating to stroke data at least partially overlapping the enclosed area on the interactive display are identified.

In Step 908, the interactive display is updated using the one or more object groups (or one or more strokes not affiliated with an object group) identified in Step 906. More specifically, the interactive display is updated to remove or clear stroke inputs corresponding to the one or more object groups (or one or more strokes). Additional details describing Step 908 are discussed below with respect to FIG. 9C.

FIG. 9B shows a flowchart describing a method for identifying object groups (or strokes not affiliated with an object group) relating to a set of stroke data in accordance with one or more embodiments of the invention. In Step 920, a set of stroke data fragments are identified. As discussed above (see e.g., FIG. 1A), stroke data may be converted from, and thus corresponds to, a single stroke input. Further, a stroke input (or stroke) may be portrayed as one or more points, and/or one or more lines connecting the one or more points, on an interactive display. In one or more embodiments of the invention, a stroke data fragment thus corresponds to a subset of the stroke data associated with a stroke input. Therefore, in one or more embodiments of the invention, a stroke data fragment may further correspond to a subset of the one or more points, and/or one or more lines, that form the stroke input. Accordingly, in one or more embodiments of the invention, a set of stroke data fragments may be a set of one or more subsets of stroke data, wherein each subset corresponds to a subset of the points and/or lines for a different stroke input.

Further to Step 920, each stroke data fragment (of the identified set of stroke data fragments) overlaps the enclosed area (extrapolated in Step 904). That is, the subset of points and/or lines forming a stroke input for which each stroke data fragment corresponds may be situated within or intersect the enclosed area. In one or more embodiments of the invention, all stroke data for every stroke input presented on an interactive display may be compared to eraser stroke data corresponding to the eraser stroke input(s), and subsequently, the enclosed area. Specifically, the location data of the stroke data and the location data of the eraser stroke data may be compared to identify at least subsets of stroke data (e.g., stroke data fragments) that lie inside and/or intersect the enclosed area.

In Step 922, for each stroke data fragment of the set of stroke data fragments identified in Step 920, contiguously associated stroke data is identified to obtain a set of stroke data. As a stroke data fragment corresponds to a subset of stroke data for a stroke input (discussed above), in one or more embodiments of the invention, contiguously associated stroke data associated with a stroke data fragment may refer to the remainder of the stroke data for the stroke input excluded from the stroke data fragment and/or residing outside the enclosed area. Put simply, in one or more embodiments of the invention, the addition of a stroke data fragment and corresponding contiguously associated stroke data equates to the totality of stroke data for a single stroke input. For any given stroke input, one or more points may be contiguously associated between a starting point and an ending point, thus producing a contiguous (or continuous) stroke. Similarly, in one or more embodiments of the invention, stroke data for the various points of a stroke input may be contiguously associated. Thus, further to Step 922, the remainder of stroke data contiguously associated with each stroke data fragment overlapping the enclosed area is identified, thereby obtaining stroke data (in entirety) for each stroke input with which each stroke data fragment is associated.

In Step 924, a lookup of the erase mode settings is performed. In one or more embodiments of the invention, the erase mode settings may be a set of one or more settings associated with the erasing functionality (or feature) of the interactive display and/or digitizer. In one or more embodiments of the invention, the settings may be representative of default values preset during the manufacturing of the interactive display and/or digitizer. In another embodiment of the invention, the settings may be representative of dynamically changing preferences of a user throughout the operation of the interactive display and/or digitizer. Examples of erase mode settings may include, but are not limited to: (i) a setting for indicating the event that triggers the enablement of the erase mode (see e.g., Step 900); (ii) a setting for whether an enclosed area is to be interpreted as a free-form or a geometric shape; (iii) a setting for whether eraser stroke inputs are to be visibly or invisibly portrayed on an interactive display prior to the disengagement (e.g., lifting) of the digitizer with the interactive display by a user; (iv) a setting for indicating which granularity of stroke data overlapping an enclosed area is removed or cleared from the interactive display, etc.

In Step 926, a determination is made based on the lookup of Step 924. More specifically, a determination is made as to whether an erase mode setting has indicated that the granularity of stroke data to be removed pertains to merely a stroke (or stroke input). If it is determined that the erase mode is set to remove just the stroke input(s) (e.g., the lowest object types) associated with the set of stroke data (identified in Step 922), the process proceeds to Step 932. On the other hand, if it is determined that the erase mode is set to remove object group(s) relating to the set of stroke data of another object type (e.g., a letter, a word, a sentence, etc.), the process proceeds to Step 928.

In Step 928, in determining that the erase mode is set to remove object group(s) of a non-stroke object type relating to the set of stroke data, the selected (non-stroke) object type is identified. In one or more embodiments of the invention, the selected object type may be a default erase mode setting preset during manufacturing of the interactive display and/or digitizer. In another embodiment of the invention, the selected object type may be an erase mode setting set by preferences exhibited by a user throughout operation of the interactive display and/or digitizer. As mentioned above, examples of the selected object type may include, but is not limited to, a letter, a word, a sentence, etc.

In Step 930, one or more object groups of the selected object type (identified in Step 928) are identified. Further, in one or more embodiments of the invention, the one or more object groups relate to the set of stroke data obtained in Step 922. Recalling the discussion of Step 922, in one or more embodiments of the invention, each stroke data of the set of stroke data corresponds to a different stroke input. Moreover, per the discussion of FIG. 4, the collective stroke data for one or more stroke inputs may be logically grouped into an object group or a set of nested object groups based on, for example, time and proximity parameters. Each object group may subsequently be associated with an object type, thereby associating the collective stroke data with a letter, a word, a sentence, and/or any other combination of stroke inputs.

Reiterating the example above in the discussion of FIG. 4, a user may write the phrase “Hello World” on an interactive display and that there are three object types: letter, word, and sentence. In this example, the stroke data corresponding to the letter “H” is associated with: (i) an object group of object type letter that is associated with all stroke data for letter “H”, (ii) an object group of object type word associated with all stroke data corresponding to the word “Hello”; and (iii) an object group of object type sentence associated with all stroke data corresponding to the words “Hello World.” In this manner, the stroke data is associated with a set of nested object groups, where each object group has a different level of granularity.

Further to the above example, consider a scenario where one of the stroke data of the set of stroke data pertained to one of the strokes that form the letter “H”. That is, in one or more embodiments of the invention, the stroke data may pertain to an object group of object type stroke (e.g., a single stroke input). In such a scenario, in one or more embodiments of the invention, Step 930 may be realized by scaling the set of nested object groups originating at the object group of object type stroke corresponding to a stroke input forming the letter “H” until the object group of the selected object type relating to the stroke data is identified. By way of an example, following the scenario, if the selected object type was set to the object type word, the object group of object type word associated with all collective stroke data corresponding to the word “Hello” would be identified. In Step 930, an object group of the selected object type for each stroke data of the set of stroke data (identified in Step 922) may identified as described above.

In Step 932, in determining that the erase mode is set to remove just stroke inputs, one or more object groups of the lowest object type (e.g., object type stroke) relating to the set of stroke data are identified. Alternatively, one or more strokes not affiliated with an object group, but associated with a collection of strokes grouped to form, for example, a drawing, a doodle, or an image, which relate to the set of stroke data are identified. In one or more embodiments of the invention, an object group associated with stroke data for a single stroke input for each stroke data identified in Step 922 may thus be identified based on the relationships specified in FIG. 4.

FIG. 9C shows a flowchart describing a method for removing stroke inputs from an interactive display in accordance with one or more embodiments of the invention. In Step 940, following the identification of one or more object groups (or one or more strokes not affiliated with an object group) relating to the set of stroke data (see e.g., FIG. 9B), the collective stroke data encompassing the set of stroke data is deleted. In one or more embodiments of the invention, deletion of the set of stroke data may include deleting the set of stroke data from volatile memory, local persistent storage, and/or cloud storage associated with the interactive device. In Step 942, in response to the deletion of the set of stroke data, the one or more stroke inputs to which the set of stroke data corresponded are removed from the interactive display. Subsequently, in one or more embodiments of the invention, the corresponding stroke input(s) would no longer be visible to, and/or be manipulated by, a user of the interactive device.

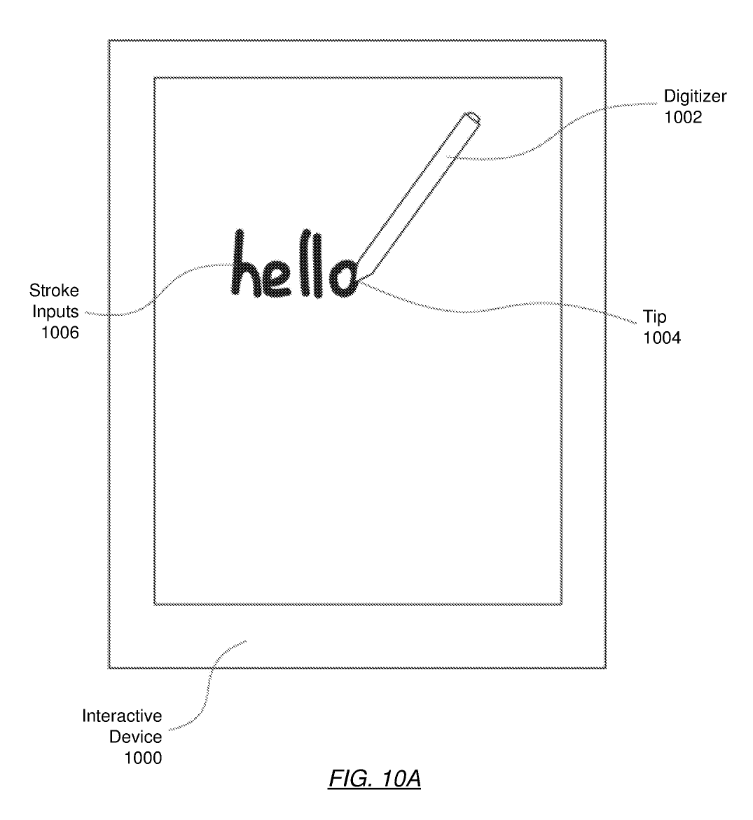

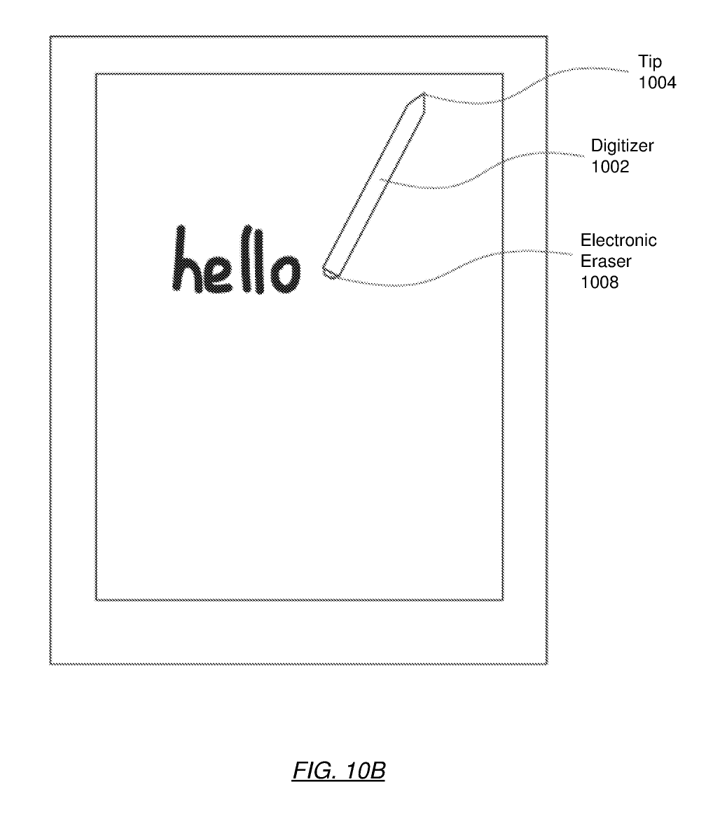

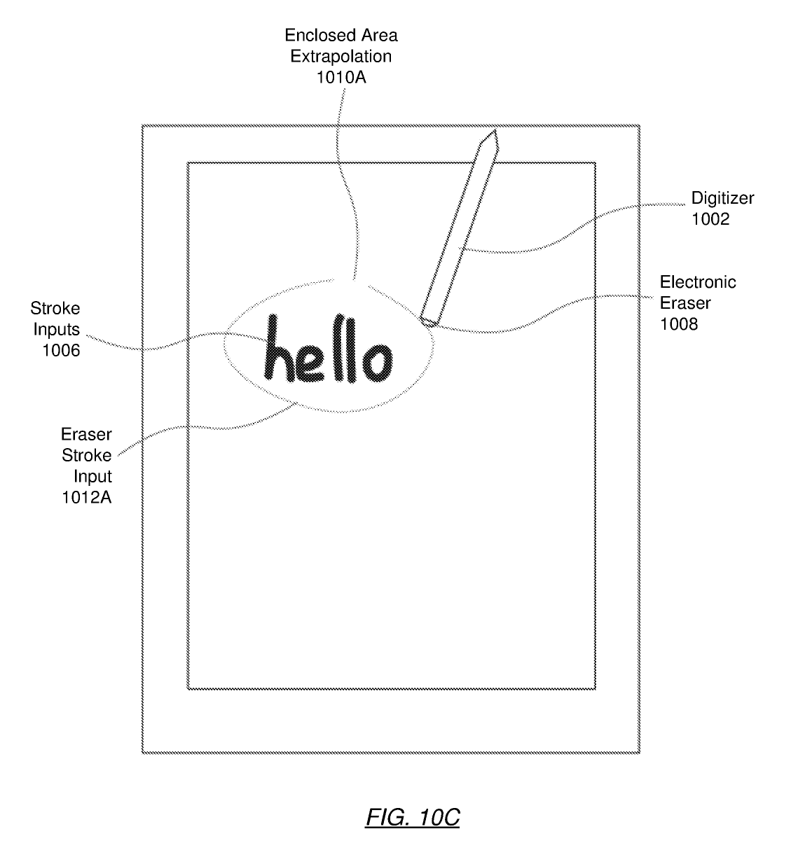

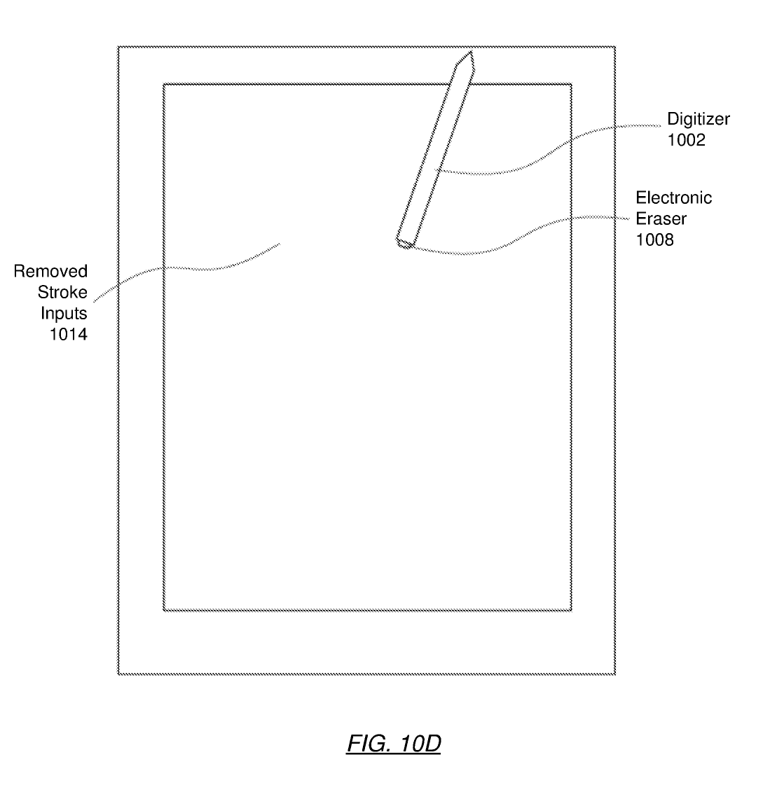

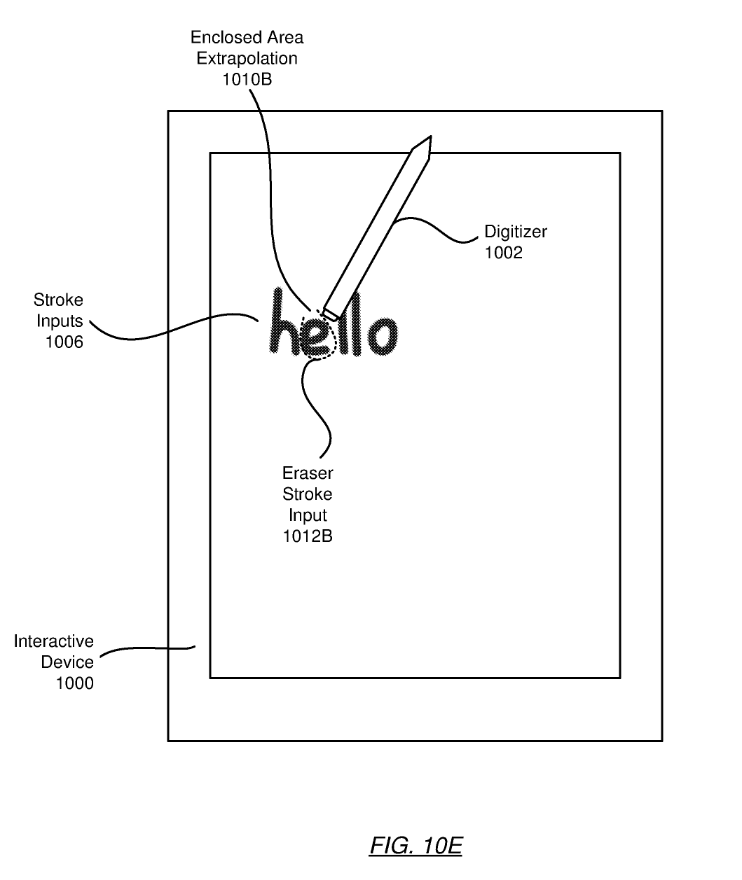

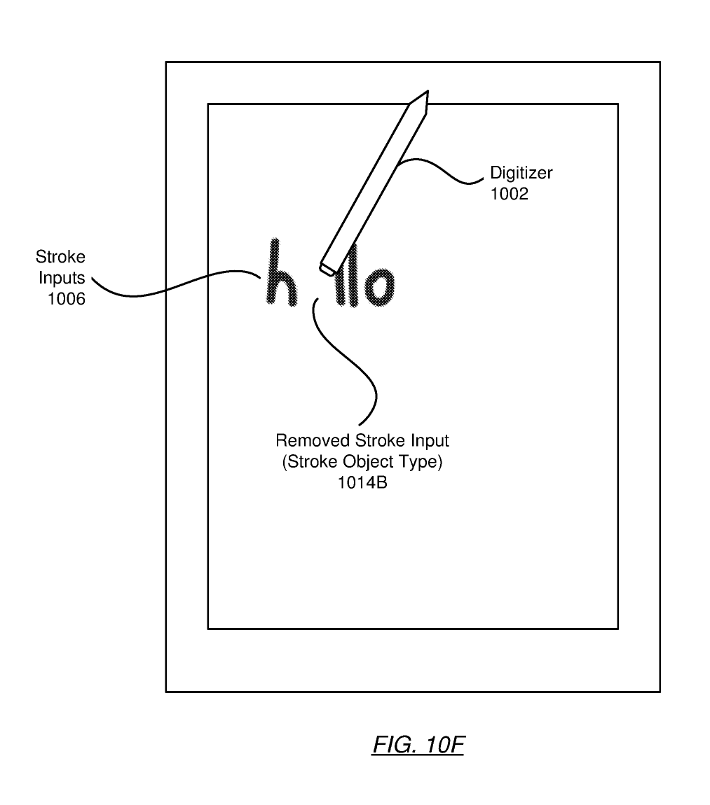

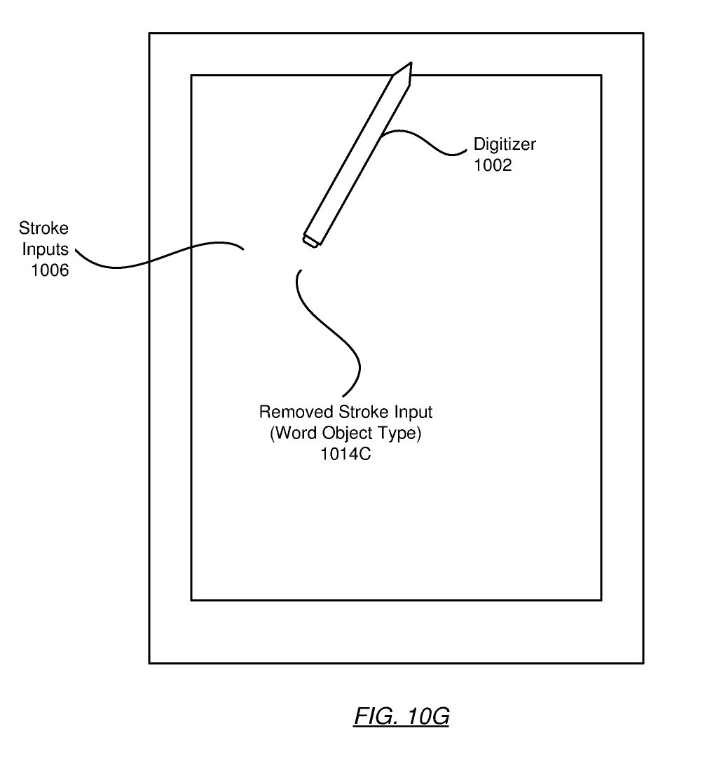

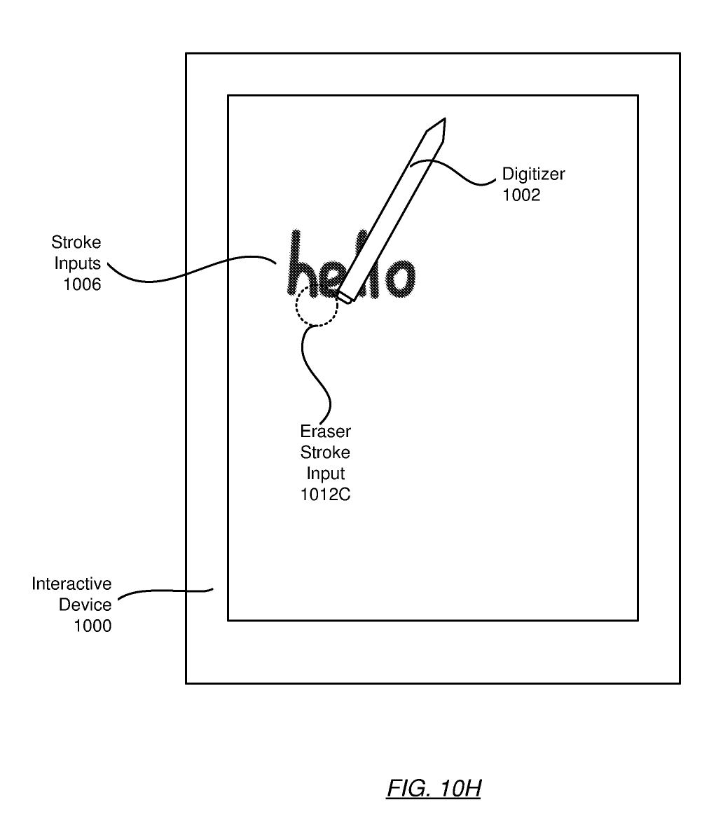

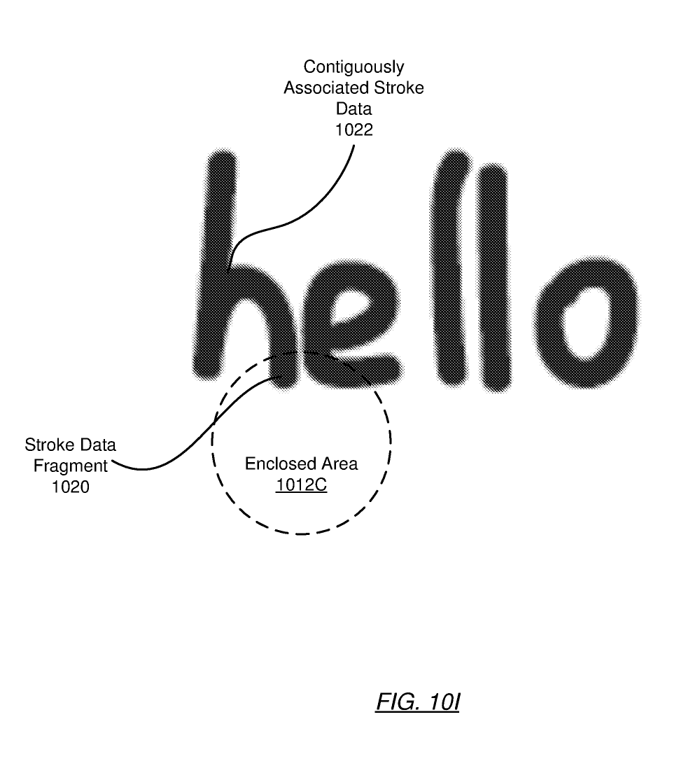

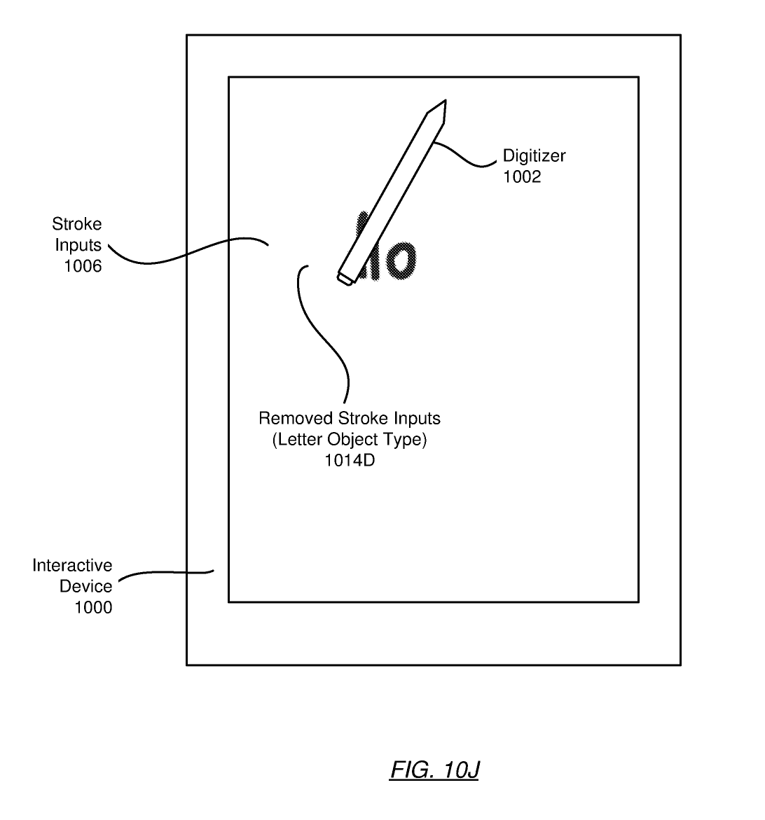

FIGS. 10A-10J show examples of one or more of the method steps described in FIGS. 9A-9C in accordance with one or more embodiments of the invention.

FIG. 10A illustrates the performing of stroke inputs (1006) to derive a word drawn on an interactive device (1000). The stroke inputs (1006) may, in one or more embodiments of the invention, be drawn using the tip (1004) of a digitizer (1002). In the instant example, the word “hello” is drawn using a series of stroke inputs, each of which may correspond to a letter of the aforementioned word. Thus, in the instant example, consider that the word “hello” may be formed by five stroke inputs corresponding to the letters “h”, “e”, “l”, “l”, and “o”. Further, each of the aforementioned letters may be considered a stroke input because a user would perform no more than a single, contiguous (or continuous) stroke to draw each of the above letters. By way of an alternative example, the word “turtle” may encompass eight stroke inputs, which may include: (i) two separate (e.g., discontinuous) strokes for each letter “t”; and (ii) one stroke for each of the remaining four letters “u”, “r”, “l”, and “e”.

Continuing with the instant “hello” example, FIG. 10B illustrates the intent of a user to evoke the erase mode of the digitizer (1002). In one or more embodiments of the invention, the erase mode may be triggered by (as shown in FIG. 10B) the flipping of the digitizer (1002) so that the electronic eraser (1008), rather than the tip (1004), is proximal to the interactive display. As illustrated in FIG. 10C, after enabling the erase mode, an eraser stroke input (1012A) performed by the user may be detected. In one or more embodiments of the invention, the eraser stroke input (1012A) may be presented (as a visible or invisible element to the user) on the interactive display, and may be converted into stroke data (or more specifically, eraser stroke data) in substantially the same manner as stroke data for the stroke inputs (1006). Further, using the eraser stroke data, an enclosed area (1010A) from which content may be removed is extrapolated. In the illustration of FIG. 10C, the enclosed area encircles the entirety of the word “hello”.

Following embodiments of the invention, one or more object groups are subsequently identified using the eraser stroke data for the eraser stroke input (1012A) and thus, the extrapolated enclosed area (1010A). More specifically, a set of stroke data corresponding to stroke inputs that at least partially overlap the enclosed area is obtained. In the instant case the enclosed area encircles the entirety of the word “hello”, thus the stroke inputs that at least partially overlap the enclosed area are identified to be all the stroke inputs (1006) forming the word “hello”. Next, in one or more embodiments of the invention, a lookup of the current erase mode settings may be performed to determine whether the erase mode is set to remove just the stroke inputs or object groups of a selected object type. In either case, since the enclosed area envelops the entirety of the word “hello”, all of the earlier identified stroke inputs of the word “hello” are removed (1014) from the interactive display as portrayed in FIG. 10D.

In another version of the example, as illustrated in FIG. 10E, consider that a user, instead, draws an eraser stroke input (1012B) to envelop just the letter “e” of the word “hello”. With respect to this version of the example, a set of stroke data for stroke inputs that at least partially overlap the enclosed extrapolated enclosed area (1010B) are first identified/obtained (see e.g., discussion with respect to FIG. 9B for details). Further to just the letter “e” being enveloped, the stroke data for the single stroke input performed to draw the letter “e” may be obtained. Following this, a lookup of the current erase mode settings may be performed and a determination as to whether just the object group of object type stroke (e.g., stroke input) or of another selected object type is to be removed.

In one or more embodiments of the invention, the erase mode may be set so that identified object groups overlapping the enclosed area, which are associated with the object type stroke (e.g., the lowest object type) are to be removed. In such an embodiment, the set of nested object groups with which the stroke data for the letter “e” is associated, may not need to be scaled because the currently obtained stroke data already corresponds to an object group associated with the object type stroke. As such, as shown in FIG. 10F, the removed stroke input (1014B) solely corresponds to the stroke input for the stroke (or letter) “e”.

In another embodiment of the invention, the erase mode may be set so that identified object groups overlapping the enclosed area, which are associated with a selected object type (e.g., a letter, a word, a sentence, etc.) are to be removed. In considering that the selected object type may equate to the object type word, in such an embodiment, the set of nested object groups with which the stroke data for the letter “e” is associated, may be scaled up to the object group associated with the selected object type, or the object type word, is identified. Further, in identifying the object group of the object type word, the collective stroke data for all stroke inputs forming the word with which the letter “e” is associated (e.g., the word “hello”) is obtained. Subsequent to this obtaining, as shown in FIG. 10G, all stroke inputs (1006) pertaining to the word “hello” are removed (1014C) from the interactive display, and the associated collective stroke data is deleted (or disassociated) from the interactive device.

In yet another version of the example, as illustrated in FIG. 10H, consider a scenario where an eraser stroke input (1012C) is performed/drawn over a portion of each of the letters “h” and “e” of the word “hello”. In this particular version of the example, following embodiments of the invention, a set of stroke data fragments may be identified first. As discussed above, a stroke data fragment may refer to a subset of the stroke data corresponding to a contiguous (or continuous) stroke or stroke input. In one or more embodiments of the invention, though, for example, the entirety of the letter “h” may not be enveloped by the enclosed area in this version of the example, the entirety of a fragment of the letter “h” is. The stroke data fragment corresponding to that fragment of the letter “h”, alongside the stroke data fragment corresponding to the fragment of the letter “e” overlapping the enclosed area, are subsequently identified.

Afterwards, in one or more embodiments of the invention, for each stroke data fragment identified, any contiguously associated stroke data is further identified. In one or more embodiments of the invention, contiguously associated stroke data associated with a stroke data fragment may refer to the remainder of the stroke data for the stroke input excluded from the stroke data fragment and/or residing outside the enclosed area. By way of an example, FIG. 10I illustrates the differentiation between a fragment of a stroke (e.g., associated with a stroke data fragment (1020)) corresponding to the letter “h” and the remainder of the stroke, which may reside outside the enclosed area (1012C) (e.g., associated with the contiguously associated stroke data (1022)). In this fashion, per the example, stroke data for the stroke inputs corresponding to the letters “h” and “e” are obtained as a set of stroke data.

Next, in one or more embodiments of the invention, a lookup of the current erase mode settings on the interactive device may be performed. Further, in one or more embodiments of the invention, one of the erase mode settings may specify that the removal of object groups associated with the object type letter is set. Subsequently, for each stroke input (e.g., associated with each stroke data of the set of stroke data), the set of nested object groups for the stroke input may be scaled until the object group associated with the object type letter is identified. From here, the collective stroke data for the aforementioned object group may be obtained (for each stroke input). Finally, the collective stroke data, for each stroke input (e.g., the letters “h” and “e”), is subsequently deleted and, as illustrated in FIG. 10J, the corresponding stroke inputs (1014D) associated with those collective stroke data are removed from the interactive display.

Software instructions in the form of computer readable program code to perform embodiments of the invention may be stored, in whole or in part, temporarily or permanently, on a non-transitory computer readable medium such as a CD, DVD, storage device, a diskette, a tape, flash memory, physical memory, or any other computer readable storage medium. Specifically, the software instructions may correspond to computer readable program code that when executed by a processor(s), is configured to perform one or more embodiments of the inventions.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A method for updating an interactive display, comprising:
detecting, by the interactive display, an eraser stroke input from a digitizer;
converting the eraser stroke input into eraser stroke data;
extrapolating an enclosed area based on the eraser stroke data;
identifying at least one object group using the enclosed area; and
updating the interactive display using the at least one object group.

2. The method of claim 1, further comprising:
prior to detecting the eraser stroke input, detecting that the digitizer is in an erase mode,
wherein the digitizer is in the erase mode when an electronic eraser of the digitizer is proximal to the interactive display.

3. The method of claim 1, further comprising:
prior to detecting the eraser stroke input, detecting that the digitizer is in an erase mode,
wherein the digitizer is in the erase mode following an activation of a button on the digitizer for enabling the erase mode.

4. The method of claim 1, wherein identifying the at least one object group using the enclosed area, comprises:
identifying a set of stroke data fragments, wherein each stroke data fragment overlaps with at least a portion of the enclosed area;
identifying stroke data for each stroke data fragment of the set of stroke data fragments to obtain a set of stroke data; and
identifying the at least one object group relating to the set of stroke data.

5. The method of claim 4, wherein the stroke data identified for each stroke data fragment is contiguously associated with the stroke data fragment.

6. The method of claim 4, wherein identifying the at least one object group relating to the set of stroke data, comprises:
performing a lookup of an erase mode setting;
determining, based on the lookup, that the erase mode setting specifies removing stroke data associated with a selected object type; and
identifying the at least one object group of the selected object type relating to the set of stroke data.

7. The method of claim 6, wherein the selected object type is one selected from a group consisting of a letter, a word, a phrase, a sentence, and a paragraph.

8. The method of claim 4, wherein identifying the at least one object group relating to the set of stroke data, comprises:
performing a lookup of an erase mode setting;
determining, based on the lookup, that the erase mode setting specifies removing stroke data associated with a lowest object type; and
identifying, based on the determining, the at least one object group of the lowest object type relating to the set of stroke data.

9. The method of claim 8, wherein the lowest object type is a stroke.

10. The method of claim 1, wherein updating the interactive display using the at least one object group, comprises:
deleting a set of stroke data relating to the at least one object group; and
removing, in response to the deleting, at least one stroke input from being displayed on the interactive display.

11. A non-transitory computer readable medium (CRM) comprising instructions, which when executed by a processor, performs a method, the method comprising:
detecting, by an interactive display, an eraser stroke input from a digitizer;
converting the eraser stroke input into eraser stroke data;
extrapolating an enclosed area based on the eraser stroke data;
identifying at least one object group using the enclosed area; and
updating the interactive display using the at least one object group.

12. The non-transitory CRM of claim 11, wherein the method further comprises:
prior to detecting the eraser stroke input, detecting that the digitizer is in an erase mode,
wherein the digitizer is in the erase mode when an electronic eraser of the digitizer is proximal to the interactive display.

13. The non-transitory CRM of claim 11, wherein the method further comprises:
prior to detecting the eraser stroke input, detecting that the digitizer is in an erase mode,
wherein the digitizer is in the erase mode following an activation of a button on the digitizer for enabling the erase mode.

14. The non-transitory CRM of claim 11, wherein identifying the at least one object group using the enclosed area, comprises:
identifying a set of stroke data fragments, wherein each stroke data fragment overlaps with at least a portion of the enclosed area;
identifying, for each stroke data fragment, stroke data to obtain a set of stroke data; and
identifying the at least one object group relating to the set of stroke data.

15. The non-transitory CRM of claim 14, wherein the stroke data identified for each stroke data fragment is contiguously associated with the stroke data fragment.

16. The non-transitory CRM of claim 14, wherein identifying the at least one object group relating to the set of stroke data, comprises:
performing a lookup of an erase mode setting;
determining, based on the lookup, that the erase mode setting specifies removing stroke data associated with a selected object type; and
identifying the at least one object group of the selected object type relating to the set of stroke data.

17. The non-transitory CRM of claim 16, wherein the selected object type is one selected from a group consisting of a letter, a word, and a sentence.

18. The non-transitory CRM of claim 14, wherein identifying the at least one object group relating to the set of stroke data, comprises:
performing a lookup of an erase mode setting;
determining, based on the lookup, that the erase mode setting specifies removing stroke data associated with a lowest object type; and
identifying, based on the determining, the at least one object group of the lowest object type relating to the set of stroke data.

19. The non-transitory CRM of claim 18, wherein the lowest object type is a stroke.

20. The non-transitory CRM of claim 11, wherein updating the interactive display using the at least one object group, comprises:
deleting a set of stroke data relating to the at least one object group; and
removing, in response to the deleting, at least one stroke input from being displayed on the interactive display.

21. A method for updating an interactive display, comprising:
detecting, by the interactive display, an eraser stroke input from a digitizer;
converting the eraser stroke input into eraser stroke data;
extrapolating an enclosed area based on the eraser stroke data;
identifying at least one stroke using the enclosed area; and
updating the interactive display using the at least one stroke.

22. The method of claim 21, wherein the at least one stroke is a subset of a collection of strokes grouped to form one selected from a group consisting of a drawing, a doodle, and an image.

23. The method of claim 21, further comprising:
prior to detecting the eraser stroke input, detecting that the digitizer is in an erase mode,
wherein the digitizer is in the erase mode when an electronic eraser of the digitizer is proximal to the interactive display.

24. The method of claim 21, further comprising:
prior to detecting the eraser stroke input, detecting that the digitizer is in an erase mode,
wherein the digitizer is in the erase mode following an activation of a button on the digitizer for enabling the erase mode.

25. The method of claim 21, wherein identifying the at least one stroke using the enclosed area, comprises:
identifying a set of stroke data fragments, wherein each stroke data fragment overlaps with at least a portion of the enclosed area;
identifying stroke data for each stroke data fragment of the set of stroke data fragments to obtain a set of stroke data; and
identifying the at least one stroke relating to the set of stroke data.

26. The method of claim 25, wherein the stroke data identified for each stroke data fragment is contiguously associated with the stroke data fragment.

27. The method of claim 21, wherein updating the interactive display using the at least one stroke, comprises:
deleting a set of stroke data relating to the at least one stroke; and
removing, in response to the deleting, at least one stroke input from being displayed on the interactive display.
